(19) United States
(12) Patent Application Publication
(10) Pub. No.: US 2011/0049274 A1
(43) Pub. Date: Mar. 3, 2011

(54) SHIELD FOR HAND HELD AIR BLOWING LANCE

(76) Inventors: Stuart Morgan, Victoria (AU); Sean Morgan, Victoria (AU)

(21) Appl. No.: 12/989,047

(22) PCT Filed: Apr. 21, 2009
(86) PCT No.: PCT/AU2009/000490

§ 371 Date: Oct. 21, 2010

(30) Foreign Application Priority Data
Apr. 21, 2008 (AU) 2008901938

(51) Int. Cl. B05B 1/00

(52) U.S. Cl. 239/591

(57) ABSTRACT

A shield and nozzle assembly having a shield that is able to be attached to a nozzle assembly, which includes an air nozzle supported by a hand-held lance at a first end and having an end cap at a second end that is opposed to the first end. The nozzle is protected from damage while air flow through the nozzle is minimally impeded.

### TECHNICAL AREA

This invention relates to the area of air nozzles and air nozzle assemblies for directing compressed air and in particular to an apparatus for use with an air nozzle which helps protect the nozzle apparatus from damage.

### BACKGROUND TO THE INVENTION

Typically hand held air blowing lances are used in many industries, one particularly prominent area being the paper industry.

These lances have a special air nozzle at one end designed to efficiently direct compressed air in an air jet of a concentrated pattern with a maximised distance of throw and maximised force to carry out whatever task is required including blowing or directing sheet paper onto the rolls of a paper mill, clearing out paper remnants from a machine where a breakage has occurred or blowing away waste from a production application.

These nozzles are typically quite costly and include safety shut off devices and triggers which are vulnerable to damage which may arise from accidental dropping of the lance on the ground or bumping it upon other objects.

Thus typically the nozzles are damaged severely with everyday use to the extent that they must be replaced more regularly than would be required were it not for accidental damage.

### OUTLINE OF THE INVENTION

It is an object of the invention to ameliorate the above problems by providing an effective protective shield or bumper for an air nozzle. It is a further object of the invention that this shield not hinder the resultant flow but preferably enhance the air flow.

The invention is a shield which is attachable to an air nozzle assembly, having an air nozzle supported by a hand held lance, such that the nozzle is protected from damage while air flow through the nozzle is not impeded.

It is preferred that the shield be coupled to the air nozzle assembly at a position between the nozzle tip and the hand held lance.

It is further preferred that this position be between the nozzle end cap and an end of the handle which would otherwise connect to the end cap.

It is preferred that the shield be generally frusto-conical in shape with a first narrower end extending forward of the nozzle aperture.

it is also preferred that a second end of the shield have a wider diameter than the first end and be spaced from the handle by means of a plurality of lugs.

It is further preferred that four equally spaced lugs be used such that air can flow into the shield at this second end and accelerate out the first end.

In order that the invention may be more readily understood we will describe by way of non limiting example one specific embodiment of the invention as detailed in the following drawings.

### BRIEF DESCRIPTION OF THE DRAWING FIGURES

FIG. 1 Shows a cross-section through the shielded hand held air blowing lance of the invention;

FIG. 2 Is an exploded diagram of the shield and nozzle and lance components;

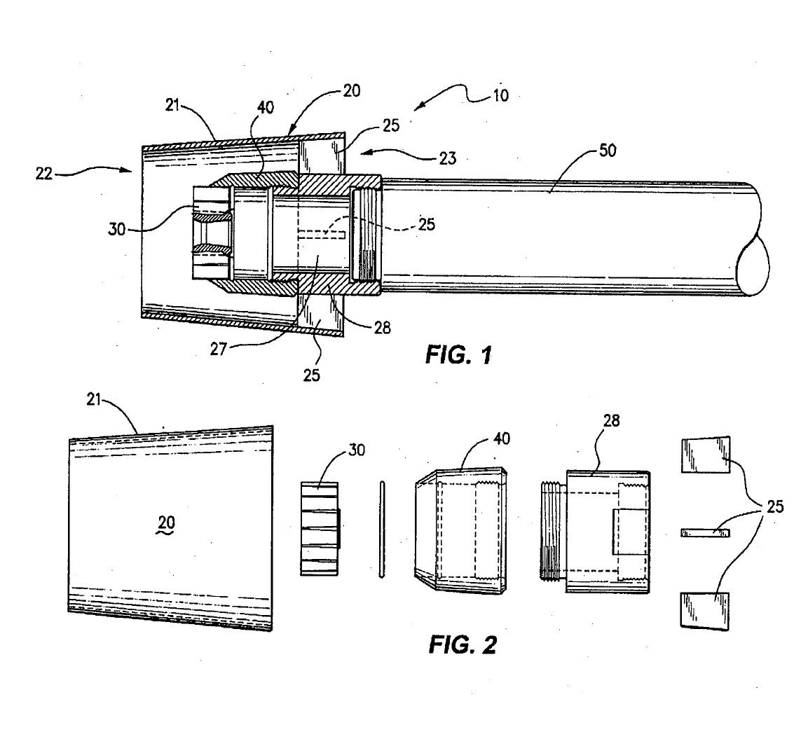

### DESCRIPTION OF AN EMBODIMENT OF THE INVENTION

The invention provides a of a hand held air blowing lance 10 for a spray nozzle having a protective shield 20 for the nozzle end of the lance which can act to direct air flow in the region so as not to disrupt the desired flow pattern.

This shield 20 has an exterior surface 21 is preferablt frusto-conical in shape such that air enters it at an end 23 of the shield having a larger diameter than that through which the air exits the shield 22, thereby accelerating the flow in the vicinity of the nozzle and enhancing its effect rather than causing any diminution of the flow.

In the absence of a shield the air nozzle 30 is located in an end cap 40 which connects directly to the handle of the air blowing lance.

The shield in this embodiment of the invention has a frusto-conical exterior as described above having adjacent its base spacers or lugs 25 extending between a support component 28 of the shield and the exterior 21.

It is preferred here that there be four such spacers or lugs 25 at equal intervals about the handle to permit air to readily flow into the shield and out its opposing end.

The support component of the shield 28 which is connected to the spacers is a circular member adapted to engage between the nozzle end cap 40 and the handle 50 and having a central aperture 27 which is concentric with that of the handle and end cap.

While in this embodiment of the invention this support component is situated adjacent a base of the shield the invention is not restricted in this regard.

The shield of the invention acts to protect the air nozzle from accidental damage and has the added advantage that its shape helps create a venturi effect which accelerates air flow through it, when the air blowing lance is in use, and hence enhances the air blowing effect of the lance rather than in any way impeding the air flow from the lance by its presence.

The exact shape of the shield is not restricted in the invention save that the frusto-conical shape described above is preferred due to its contribution to the flow.

Neither is the number of spacers or lugs used to hold the shield exterior out from the air blowing lance in any way restricted in the invention although the number preferred here is designed to provide minimal impediment to air flow which still providing sufficient strength to effect the purpose of the shield.

The is also no restriction on the type of materials used in the manufacture of the shield save that they be appropriate for the purpose required.

While we nave described herein one particular embodiment of the invention it is envisaged that other embodiments of the invention could exhibit variations in the features described and it is envisaged that other embodiments of the invention will exhibit any number of and combination of the features previously described and it is to be understood that variations and modifications in this can be made without departing from the spirit and scope thereof.

1-7. (canceled)

8. A shield and nozzle assembly, comprising:
a nozzle for discharging a fluid supported by a hand-held lance at a first end thereof and an end cap at a second end with said second end being an opposing end to said first end; and,
a shield attachable to said first end of said hand-held lance, said nozzle being protected from damage while fluid flow through said nozzle is minimally impeded.

9. The shield and nozzle assembly according to claim 8, wherein said nozzle is an air nozzle.

10. The shield and nozzle assembly according to claim 8, wherein said shield is coupled to a fluid nozzle assembly at a coupling position located between a tip of said nozzle and said hand-held lance.

11. The shield and nozzle assembly according to claim 8, wherein said shield is a substantially annular device extending laterally from said nozzle and supported by lugs extending therefrom.

12. The shield and nozzle assembly according to claim 8, wherein said shield has a substantially frusto-conical shape with a narrower end of said shield extending forward of an aperture of said nozzle.

13. The shield and nozzle assembly according to claim 12, wherein said narrower end of said shield is a first end and said shield has a second end having a wider diameter than said first end thereof and is spaced from a handle via a plurality of lugs.

14. The shield and nozzle assembly according to claim 13, wherein said plurality of lugs is four substantially equally-spaced lugs for directing air flow into said shield at said second end and accelerates the air flow out of said first end.

15. The shield and nozzle assembly according to claim 8, wherein said shield includes a plurality of spaced apart lugs for directing fluid flow into said shield at said second end and accelerating the fluid flow out of said first end.
